(19) United States
(12) Patent Application Publication
(10) Pub. No.: US 2008/0049036 A1
(43) Pub. Date: Feb. 28, 2008

(54) Multimedia Playback System, FIFO Memory System, and Method for Storing Multimedia Data

(75) Inventor: Chi-Lun Chang, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/466,991

(22) Filed: Aug. 24, 2006

(51) Int. Cl. G09G 5/36

(52) U.S. Cl. 345/558

(57) ABSTRACT

A multimedia playback system, a FIFO memory system, and a method for storing multimedia data are provided. The multimedia playback system or the FIFO system comprises a FIFO memory and a memory controller. The FIFO memory buffers a first and a second multimedia data. The memory controller allocates the FIFO memory according to allocation information. The first and second multimedia data are synchronous during playback. The allocation information depends on a first throughput rate of the first multimedia data and a second throughput rate of the second multimedia data. The method comprises the following steps: providing a FIFO memory for buffering the first and second multimedia data; and allocating the FIFO memory according to allocation information.

### CROSS-REFERENCES TO RELATED APPLICATIONS

Not applicable

### BACKGROUND OF THE INVENTION

1. Field of the Invention

The present invention relates to a multimedia playback system, a FIFO memory system, and a method for storing multimedia data. In particular, the invention relates to a multimedia playback system, a FIFO memory system and a method for allocating memory according to the throughput rate of the multimedia data.

2. Descriptions of the Related Art

For multimedia playback systems, the anti-shock mechanism has always been of serious concern for research and development, especially for those multimedia playback systems adapted for vehicles or sports. Normally, the speed of data read on a multimedia carrier, such as an optical disc, is faster than the speed of streams processed during continuous playback. However, continuous playback is hindered under shock conditions; thus, there are two conventional ways that address this problem. One is to enhance the hardware mechanism of multimedia playback systems so that data read from the optical disc would not be interrupted during shock. The other way is to arrange a larger buffer, such as a FIFO memory, to buffer more multimedia data. Yet, both these ways result in a cost increase. Furthermore, because there are different multimedia carriers in the market, e.g., VCD, DVD, SVCD, and Blu-ray disc, etc., different FIFO memory configurations are required due to the varying ratios of audio and video data streams. Accordingly, an anti-shock solution is still needed in this industrial field.

### SUMMARY OF THE INVENTION

An object of the invention is to provide a FIFO memory system. The FIFO memory system comprises a FIFO memory and a memory controller. The FIFO memory is configured to buffer a first and a second multimedia data. The memory controller is configured to allocate the FIFO memory to store the first and second multimedia data according to allocation information. The first and second multimedia data are synchronous. The allocation information depends on a first throughput rate of the first multimedia data and a second throughput rate of the second multimedia data.

Another object of this invention is to provide a method for storing a first and a second multimedia data. The method comprises the following steps: providing a FIFO memory for buffering the first and second multimedia data; and allocating the FIFO memory to store the first and second multimedia data according to allocation information. The first and second multimedia data are synchronous. The allocation information depends on a first throughput rate of the first multimedia data and a second throughput rate of the second multimedia data.

Another object of this invention is to provide a multimedia playback system. The multimedia playback system comprises a FIFO memory and a memory controller. The FIFO memory is configured to buffer a first and a second multimedia data. The memory controller is configured to allocate the FIFO memory to store the first and second multimedia data according to allocation information. The first and second multimedia data are synchronous. The allocation information depends on a first throughput rate of the first multimedia data and a second throughput rate of the second multimedia data.

Yet a further object of this invention is to provide a FIFO memory system. The FIFO memory system comprises means for buffering a first and a second multimedia data; and means for allocating the FIFO memory to store the first and second multimedia data according to allocation information. The first and second multimedia data are synchronous. The allocation information depends on a first throughput rate of the first multimedia data and a second throughput rate of the second multimedia data.

The present invention prevents discontinuous playback due to shock by allocating a FIFO memory according to the throughput rates of multimedia data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a block diagram of a first embodiment of the present invention;

FIG. 2 shows a flow chart of a second embodiment in accordance with the present invention;

FIG. 3 shows a flow chart of a third embodiment in accordance with the present invention;

FIG. 4 shows a flow chart of a fourth embodiment in accordance with the present invention; and

FIG. 5 shows a flow chart of a fifth embodiment in accordance with the present invention.

### DESCRIPTION OF THE PREFERRED EMBODIMENT

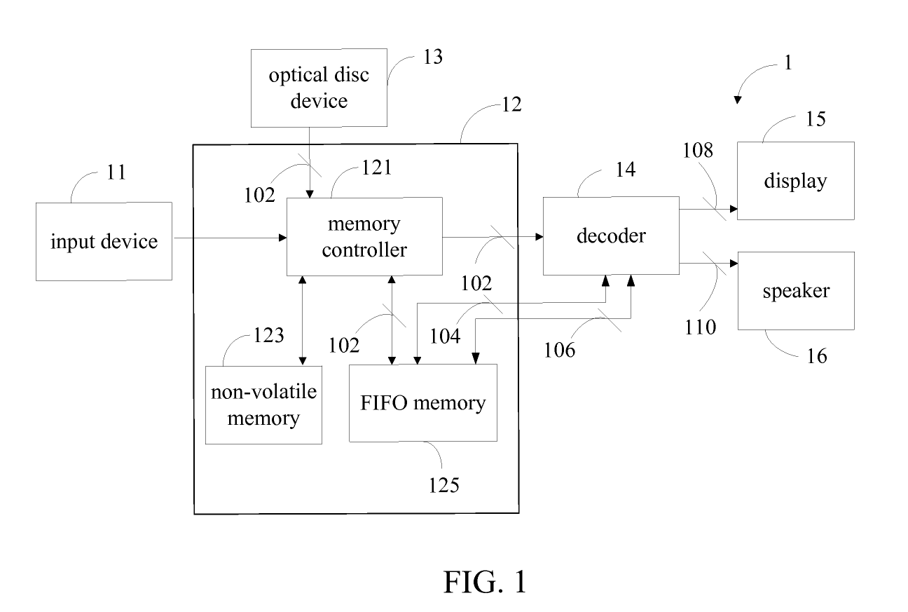

A first embodiment of the present invention is a multimedia playback system 1 as shown in FIG. 1. The multimedia playback system 1 comprises an input device 11, a FIFO memory system 12, an optical disc device 13, a decoder 14, a display 15, and a speaker 16. The input device 11 is configured for users to input instructions. The FIFO memory system 12 comprises a memory controller 121, a non-volatile memory 123, and a FIFO memory 125. The memory controller 121 may be a CPU of the multimedia playback system 1 and is configured to control data flow. The non-volatile memory 123 is used to store codes for booting and operating. A flash memory or an EEPROM is an example of a non-volatile memory. In this first embodiment, the FIFO memory 125 is a DRAM.

When the user inputs a playback instruction via the input device 11, the memory controller 121 reads a multimedia data 102 from the optical disc device 13 and transmits it to the FIFO memory 125 for buffering. The multimedia data 102 may comprise audio, video, subtitle, still image, navigation data and/or texture data. Some of these data should be synchronous during playback. For example, the audio and video data require synchronization; otherwise, the sound and display during playback would not match each other. The audio data and the video data are used hereinafter for illustration.

The decoder 14 further comprises a first decoder for decoding the video data and a second decoder for decoding the audio data. For the VCD format, the bit rate of the video data is 1150 kbps (kilo bits per second) and the bit rate of the audio data is 224 kbps. For the SVCD format, the bit rate of the video data ranges from 1700-2000 kbps on average, with a maximum of 2600 kbps. The bit rate of the audio data ranges from 32-384 kbps. For the DVD format, the bit rate of the video data can reach up to 9800 kbps in the MPEG2 and 1856 kbps in the MPEG1, with the bit rate of the audio data ranging from 32-1536 kbps. For the DIVX format, the bit rate of the video data is 4000 kbps on average and 8000 kbps at maximum, with the bit rate of the audio data ranging from 8-384 kbps in the MPEG 1 Layer 2 and from 32-640 kbps in the AC3.

The memory controller 121 then allocates the FIFO memory 125 for buffering the audio data 104 and the video data 106 according to the allocation information. The memory controller 121 manages the FIFO mechanism by controlling a read and write pointer during access to the FIFO memory 125. The allocation information depends on the throughput rates, e.g., the bit rates of the audio data 104 and the video data 106. As mentioned above, the bit rates vary in terms of disc formats. In the first embodiment, two allocation ways are provided. One is to set a constant ratio between the FIFO memory 125 space for buffering the video data 106 and the audio data 104 if the allocation information indicates a constant ratio between the bit rates of the video data 106 and the audio data 104 for most of the time. For example, the memory controller 121 would allocate the FIFO memory 125 space for buffering the video data 106 and the audio data 104 at 1150:224 if the disc is a VCD. The ratio can be derived from a table which is established in advance.

The other way is to set a variable ratio in terms of time for buffering the video data 106 and the audio data 104 in the FIFO memory 125 space if the allocation information indicates a variable ratio between the bit rates of the video data 106 and the audio data 104. For example, the memory controller 121 allocates a variable FIFO memory 125 space for buffering the video data 106 and the audio data 104 if the disc is a SVCD, DVD, or DIVX. More specifically, the allocation ratio of the FIFO memory 125 space may be determined according to the video data 106 and the audio data 104 as a whole or partially. That is, the allocation ratio is calculated by averaging the data 104, 106 in whole or in part. For example, if the disc is a DVD, partial consideration would include one title of the DVD. Thus, the varying allocation ratios can be used to allocate the FIFO memory 125, providing a more precise adjustment against the shock effect.

When the video data 106 and the audio data 104 are about to be played, the video data 106 is transmitted from the FIFO memory 125 to the decoder 14 for decoding. After decoding, decoded video data 108 is generated. The decoded video data 108 is transmitted to the display 15. Similarly, the audio data 104 is transmitted from the FIFO memory 125 to the decoder 14 for decoding. After decoding, a decoded audio data 110 is generated. The decoded audio data 110 is transmitted to the speaker 16. Since the FIFO memory 125 space for buffering the video data 106 and the audio data 104 is allocated based on their throughput rates, the outputs of the display 15 and the speaker 16 may be synchronized even if a shock occurs.

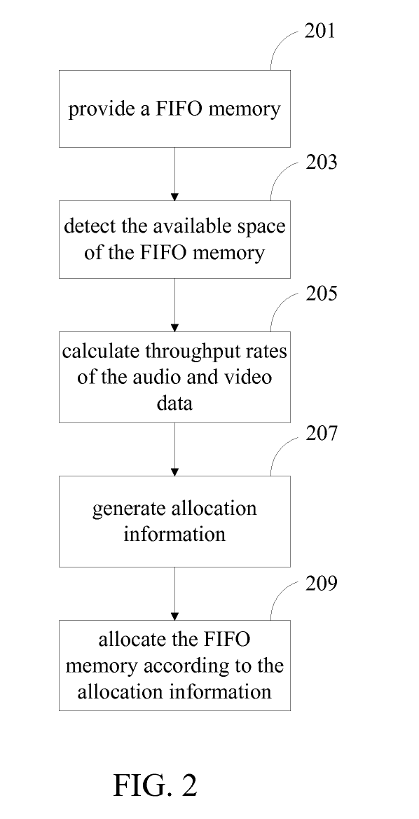

A second embodiment of the present invention is a method for storing audio and video data. The second embodiment is adapted for any multimedia playback system, such as the illustrated multimedia playback system 1. FIG. 2 shows a flow chart of the second embodiment. In step 201, a FIFO memory, such as the FIFO memory 125, is provided for buffering the audio and video data. Then, step 203 is executed in which a memory controller, such as the memory controller 121, detects the space of the FIFO memory. In step 205, the memory controller calculates throughput rates of the audio and video data. In step 207, the memory controller generates allocation information in response to the calculation. In step 209, the memory controller allocates the FIFO memory according to the allocation information. The memory controller may free the buffered memory within the FIFO memory if the data inside has already been read by a decoder. At that point, the freed FIFO memory is able to buffer other multimedia data from an optical disc device. The memory controller can then manage the FIFO memory dynamically, so the audio and video data can be played synchronously.

In addition to the steps shown in FIG. 2, the second embodiment is capable of performing all the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

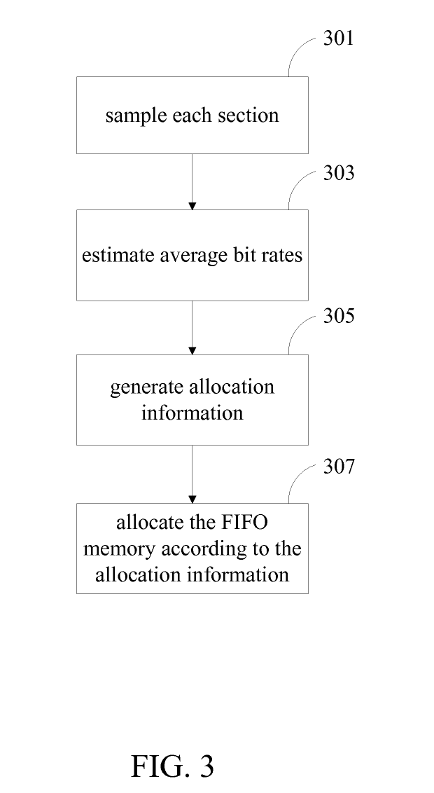

A third embodiment of the present invention is also a method for storing audio and video data in a FIFO memory. The third embodiment is adapted for a multimedia playback system, such as the illustrated multimedia playback system 1. In the third embodiment, the audio and video data are separated into several sections, with each section comprising a title if the disc is a DVD disc or comprising a track if the disc is a VCD or SVCD disc. FIG. 3 shows a flow chart of the third embodiment. In step 301, the memory controller samples each section. In step 303, the memory controller estimates average bit rates per section according to the sampling. In step 305, the memory controller generates allocation information per section according to the average bit rates. In step 307, the memory controller allocates the FIFO memory according to the allocation information, whereby the audio and video data can be played synchronously.

The section comprises at least one title or track. During playback flow, if the multimedia player finishes playing this section and continues to play a next section, the FIFO memory can be freed and all the buffered multimedia data in the FIFO memory can be cleaned. A portion of the multimedia data meeting the aforementioned rule is defined as a section. If the next section is chosen to be played, corresponding section allocation information would be used for allocating the FIFO memory before playing.

In addition to the steps shown in FIG. 3, the third embodiment is capable of performing all the operations or functions recited in the first embodiment. Those skilled in the art can straightforwardly realize how the third embodiment performs these operations and functions based on the above descriptions of the first embodiment. Therefore, the descriptions for these operations and functions are redundant and not repeated herein.

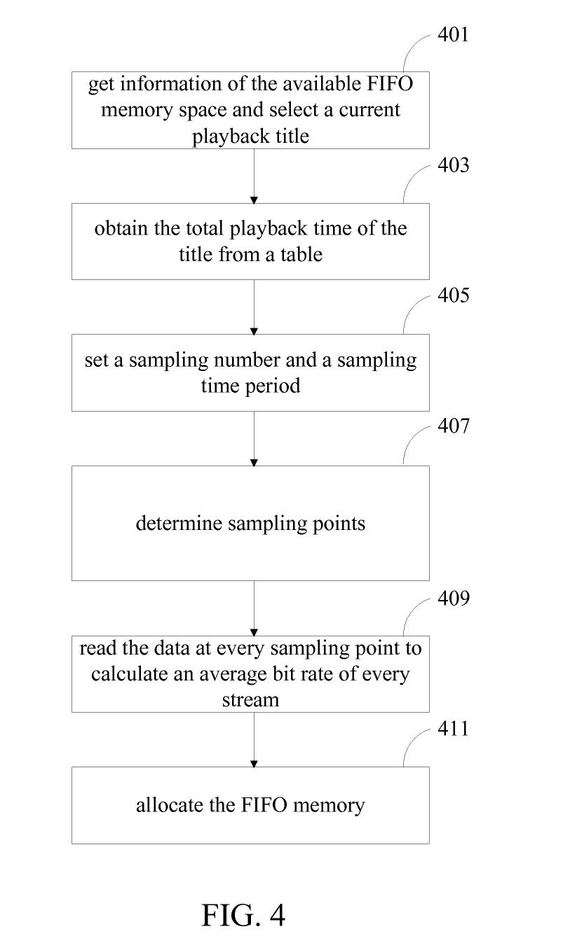

A fourth embodiment of the present invention is another method for processing multimedia data stored on a DVD disc. The multimedia data is separated into several sections, with each section comprising a title. FIG. 4 shows a flow chart of the fourth embodiment. In step 401, the DVD player gets information of the available FIFO memory space and selects a current playback title. In step 403, the DVD player obtains the total playback time, or TTPS, of the title from a DVD PGC_PB_TIME table. In step 405, a sampling number, N, and a sampling time period, T, are set. In step 407, the DVD player determines sampling points in the title according to the sampling number N and the sampling time period T. For example, the N sampling points can be distributed at the playback times (TTPS/2N−T/2)×1, (TTPS/2N−T/2)×3 . . . (TTPS/2N−T/2)×(2N−1). In step 409, the DVD player reads the data at every sampling point to calculate an average bit rate of every stream, such as a video, audio, subtitle, or navigation (NV) stream data in the title. For example, if the video data at all sampling points are VTB1, VTB2 . . . VTBN, the average bit rate of the video data in the title can be estimated as VTB, (Σ₁^{N}VTBn)/N. In step 411, the DVD player allocates the FIFO memory according to the average bit rates per title. If another title is played, the corresponding title allocation information is used for allocating the FIFO memory before playing. A similar flow chart can be applied to the track of VCD or SVCD disc.

In addition to the steps shown in FIG. 4, the fourth embodiment is capable of performing all the operations or functions recited in the first embodiment. Those skilled in the art can straightforwardly realize how the fourth embodiment performs these operations and functions based on the above descriptions of the first embodiment. Therefore, the descriptions for these operations and functions are redundant and not repeated herein.

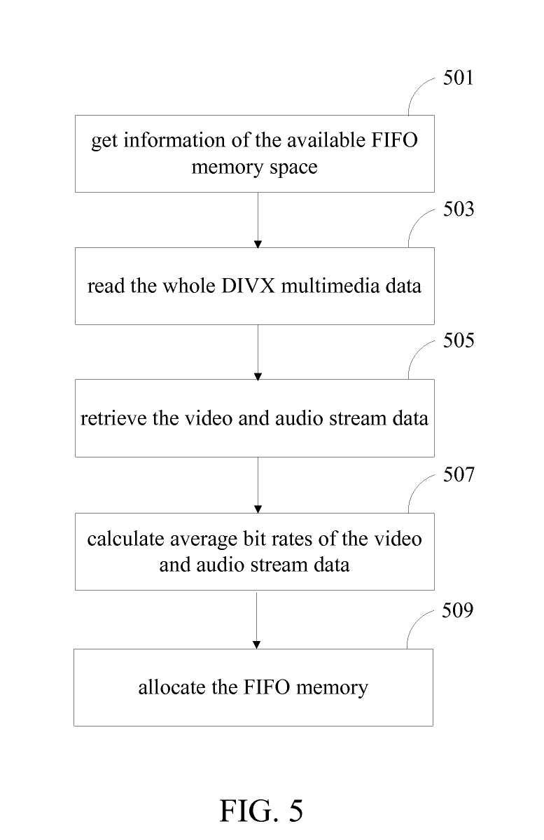

A fifth embodiment of the present invention is another method for processing multimedia data stored in a DIVX format. FIG. 5 shows a flow chart of the fifth embodiment. In step 501, the system gets information of the available FIFO memory space. In step 503, the system reads the entire DIVX multimedia data. In step 505, the system retrieves the video and audio stream data during paring. In step 507, the average bit rates of the video and audio stream data are calculated by dividing the data size by the total playback time. In step 509, the system allocates the FIFO memory according to the ratio of the average bit rates.

In addition to the steps shown in FIG. 5, the fifth embodiment is capable of performing all the operations or functions recited in the first embodiment. Those skilled in the art can straightforwardly realize how the fifth embodiment performs these operations and functions based on the above descriptions of the first embodiment. Therefore, the descriptions for these operations and functions are redundant and not repeated herein.

The present invention is capable of allocating the FIFO memory of different multimedia data according to the throughput rates of the multimedia data. The problem of discontinuous playback due to, for example, shock, can be solved thereby.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A FIFO (first-in first-out) memory system, comprising:
a FIFO memory for buffering a first and a second multimedia data; and
a memory controller for allocating the FIFO memory to store the first and second multimedia data according to allocation information;
wherein the first and second multimedia data are synchronous, and the allocation information depends on a first throughput rate of the first multimedia data and a second throughput rate of the second multimedia data.

2. The system as claimed in claim 1, wherein the first multimedia data is decoded by a first decoder, and second multimedia data is decoded by a second decoder.

3. The system as claimed in claim 1, wherein the FIFO memory is a DRAM.

4. The system as claimed in claim 1, wherein the first multimedia data is one of audio, video, subtitle, still image, texture data, and navigation data.

5. The system as claimed in claim 1, wherein the allocation information is derived from a table.

6. The system as claimed in claim 1, wherein a ratio of the first throughput rate to the second throughput rate is constant.

7. The system as claimed in claim 1, wherein a ratio of the first throughput rate to the second throughput rate is variable in terms of time.

8. The system as claimed in claim 7, wherein the ratio is derived by considering the first multimedia data and the second multimedia data as a whole.

9. The system as claimed in claim 7, wherein the ratio is derived by considering a part of the first multimedia data and a part of the second multimedia data.

10. The system as claimed in claim 9, wherein the part of the first multimedia data is a title of a DVD disc or a track of a VCD/SVCD disc.

11. A method for storing a first and a second multimedia data, comprising steps of:
providing a FIFO memory for buffering the first and second multimedia data; and
allocating the FIFO memory to store the first and second multimedia data according to allocation information;
wherein the first and second multimedia data are synchronous, and the allocation information depends on a first throughput rate of the first multimedia data and a second throughput rate of the second multimedia data.

12. The method as claimed in claim 11, wherein the first multimedia data is decoded by a first decoder, and second multimedia data is decoded by a second decoder.

13. The method as claimed in claim 11, wherein the FIFO memory is a DRAM.

14. The method as claimed in claim 11, wherein the first multimedia data is one of audio, video, subtitle, still image texture data, and navigation data.

15. The method as claimed in claim 11, wherein the allocation information is derived from a table.

16. The method as claimed in claim 11, wherein a ratio of the first throughput rate to the second throughput rate is constant.

17. The method as claimed in claim 11, wherein a ratio of the first throughput rate to the second throughput rate is variable in terms of time.

18. The method as claimed in claim 17, wherein the ratio is derived by considering the first multimedia data and the second multimedia data as a whole.

19. The method as claimed in claim 17, wherein the ratio is derived by considering a part of the first multimedia data and a part of the second multimedia data.

20. The method as claimed in claim 19, wherein the part of the first multimedia data is a title of a DVD disc or a track of a VCD/SVCD disc.

21. A multimedia playback system, comprising:
a FIFO memory for buffering a first and a second multimedia data; and
a memory controller for allocating the FIFO memory to store the first and second multimedia data according to allocation information;
wherein the first and second multimedia data are synchronous, and the allocation information depends on a first throughput rate of the first multimedia data and a second throughput rate of the second multimedia data.

22. A FIFO memory system, comprising:
means for buffering a first and a second multimedia data; and
means for allocating the FIFO memory to store the first and second multimedia data according to allocation information;
Wherein the first and second multimedia data are synchronous, and the allocation information depends on a first throughput rate of the first multimedia data and a second throughput rate of the second multimedia data.
